(19) United States
(12) Patent Application Publication
(10) Pub. No.: US 2025/0338372 A1
(43) Pub. Date: Oct. 30, 2025

(54) BRAKE LIGHT MODULATION DEVICE WITH CONSTANT OUTPUT CURRENT

(71) Applicant: Williams & Lake, LLC, Las Vegas, NV (US)

(72) Inventors: Bradley J. Dorsey, Las Vegas, NV (US); Brian Wittman, Indianapolis, IN (US); Samuel Elkin, Indianapolis, IN (US)

(21) Appl. No.: 19/189,189

(22) Filed: Apr. 24, 2025

Related U.S. Application Data
(60) Provisional application No. 63/638,044, filed on Apr. 24, 2024.

(51) Int. Cl. H05B 45/345; B60Q 1/44; H05B 47/28

(52) U.S. Cl. CPC H05B 45/345; B60Q 1/444; H05B 47/28

(57) ABSTRACT

A brake light detection device includes an output transistor arranged in an output path and a shunt transistor arranged in a shunt path. The brake light modulation device further includes a controller configured to receive a current signal from an input current detector and provide control signals to the output transistor and the shunt transistor. The control signals are configured to (i) modulate an output current delivered through to the output path during a vehicle braking event and (ii) maintain the magnitude of the current applied to the input line such that the magnitude of the current applied to the input line remains constant during the vehicle braking event. Modulation of the output current includes on-intervals and off-intervals. The controller is further configured to control the shunt transistor and the output transistor to sub-modulate the output current during the off-intervals.

### CROSS-REFERENCE TO RELATED APPLICATIONS

This application claims priority to U.S. Provisional Patent Application No. 63/638,044, filed Apr. 24, 2024, the contents of which are incorporated herein by reference in their entirety.

### FIELD

This document relates to the field of brake lighting in vehicles, and particularly to devices configured to provide flashing or modulated brake lights upon application of a vehicle brake.

### BACKGROUND

Brake lights are standard equipment in many vehicles including automobiles designed to drive on public roads in the United States or other countries. Brake lights may be provided in any of various forms, but are typically provided as incandescent bulbs or LEDs. The term “brake light” as used herein is intended to refer to any illuminating device intended to indicate braking, deceleration, or stopping of a vehicle, including incandescent bulbs or LEDs. Brake lights are sometimes referred to by other terms such as “stop lamps” or “brake lamps”, and such terms are used interchangeably herein.

Stop lamp flasher devices of various designs are known in the art. Stop lamp flasher devices are typically configured to modulate the intensity of light output from a CHM SL (center high mounted stop lamp) or other brake light such that the light appears to turn on and off rapidly (or vary the power output of the brake light) in order to alert a driver behind a stopping vehicle that the flasher-equipped vehicle is stopping. The flashing lights associated with stop lamp flasher devices generally obtain the attention of a trailing driver more quickly, thus providing the trailing driver with additional time to respond to the braking vehicle in front of them. In addition, persons who frequently drive in stop-and-go city traffic may become less responsive to ordinary brake lights, and the flashing lights associated with stop lamp flasher devices may be used to gain the attention of these drivers on shorter notice. An exemplary stop lamp flasher device is shown in U.S. Pat. No. 9,475,424, the contents of which are incorporated herein by reference in their entirety.

M any stop lamp flasher devices do not actually turn the brake light on and off, but instead modulate or vary the power output by the brake light. For example, a stop lamp flasher device may rapidly vary the power output from a brake light between 100% and 50% (i.e., a first power output being 100% and a second power output being 50% of the first power output). As such, stop lamp flasher devices may be considered to “modulate” the brake light instead of flashing the brake light. However, because this modulation is relatively rapid, a human is typically unable to determine whether the intensity of the brake lamp is being modulated or is flashing. Therefore, the terms “modulate” and “flash” are used interchangeably in this document to simply refer to some relatively rapid variation in the power output from a vehicle, whether between 0% and 100%, 50% and 100%, 40% and 90%, or any other power variation.

Many stop lamp modulation devices are offered for sale in the aftermarket and either installed by the owner of an existing vehicle or by dealers prior to the sale of a vehicle. One issue with existing stop lamp modulation devices is that they may not operate properly with certain modern automobiles that include automated computer diagnostic capabilities. For example, when a stop lamp modulation device is installed in certain automobiles, the fault detection circuitry may improperly detect that there is a problem with the brake light. In these situations, the fault detection circuitry may not expect any varying current across the brake light during braking, and therefore may consider varying current across the brake light as a fault. When the fault detection circuitry improperly detects a problem with the brake light, a warning indication may be presented to the vehicle operator on the dash or other vehicle location. This indication may be annoying to the vehicle operator and cause concern even though the stop lamps are indeed functioning properly. Alternatively, a detected problem with the brake lamp may cause some vehicles to suspend operation of the brake lamp for some period of time.

In view of the foregoing, it would be advantageous to provide a stop lamp modulation device that works with modern vehicles that include fault detection circuitry for the brake light circuit. It would be advantageous if such device could be easily installed in an existing vehicle by simply coupling additional circuitry to the brake light circuit in the vehicle. It would also be advantageous if the stop lamp modulation device could be produced at relatively little cost and with a relatively small package size. Additionally, it would be advantageous for the improved stop lamp modulation device to be configured for use with vehicle braking circuits on numerous different vehicles.

### SUMMARY

In at least one embodiment, a brake light modulation device is configured for installation in a brake line circuit of a vehicle. The brake line circuit of the vehicle includes a supply line and a return line. The brake light modulation device includes a first lead, a second lead and a third lead. An input path of the brake light modulation device is connected to the first lead, an output path is connected to the second lead, and a ground connection is provided at the third lead. The brake light modulation device further includes an input current detector connected to the input path, the input current detector configured to detect a magnitude of a current applied to the input line. The brake light modulation device further includes an output transistor arranged in the output path, and a shunt transistor arranged in a shunt path extending between a shunt node and the third lead, the shunt node connecting the input path to the output path. Additionally, the brake light modulation device includes a controller configured to receive a current signal from the input current detector, the current signal indicative of the magnitude of the current applied to the input line during a vehicle braking event including during an initial time period of the vehicle braking event, and provide control signals to the output transistor and the shunt transistor, the control signals configured to (i) modulate an output current delivered through to the output path at the second lead after the initial time period during the vehicle braking event and (ii) maintain the magnitude of the current applied to the input line after the initial time period such that the magnitude of the current applied to the input line remains constant during the vehicle braking event.

In at least one embodiment, a brake light modulation device is configured for installation in a brake line circuit of a vehicle, the brake line circuit including a supply line and a return line. The brake light modulation device includes a first lead, a second lead and a third lead, a first transistor, a second transistor and a controller. An input path of the brake light modulation device is connected to the first lead, an output path is connected to the second lead, and a ground connection is provided at the third lead. The first transistor is connected between the first lead and the second lead. The second transistor is connected between the first lead and the third lead. The controller is configured to provide control signals to a first transistor and the second transistor, the control signals configured to modulate an output voltage at the second lead between a plurality of on-intervals and a plurality of off-intervals, wherein a steady output voltage is provided during the on-intervals, and wherein a sub-modulated output voltage is provided during the off-intervals.

In at least one embodiment, a method is provided for controlling illumination of a brake light in a brake light circuit of a vehicle, wherein the brake light circuit includes the brake light and brake light wiring, the brake light wiring including a brake light supply line and a return line. The method includes first cutting the brake light wiring such that at least one line of the brake light wiring is a severed line, the severed line including a first severed end and a second severed end. Thereafter, the method includes connecting a first terminal of a brake light modulation device to the first severed end, connecting a second terminal of the brake light modulation device to the second severed end, and connecting a third terminal of the brake light modulation device to the brake light wiring. Thereafter, the method includes applying a vehicle brake and controlling current flow through an output transistor and a shunt transistor of the brake light modulation device in order to modulate illumination of the brake light, wherein said modulation includes on-intervals and off-intervals. The method further includes controlling current flow through the output transistor and the shunt transistor during the off-intervals includes sub-modulating illumination of the brake light during the off-intervals.

### BRIEF DESCRIPTION OF THE DRAWINGS

FIG. 1 shows a block diagram of a brake light modulation device;

FIG. 2 shows a graph of the output voltage of one exemplary embodiment of the brake light modulation device of FIG. 1 during a braking event;

FIG. 3 shows a schematic for another exemplary embodiment of the brake light modulation device of FIG. 1;

FIG. 4 shows a graph of the output voltage of the brake light modulation device of FIG. 3 during a braking event;

FIG. 5 shows a schematic of an ASIC (“Application Specific Integrated Circuit) used in the schematic of FIG. 3; and

FIG. 6 shows a block diagram of the brake light modulation device of FIG. 1 installed in a vehicle.

### DESCRIPTION

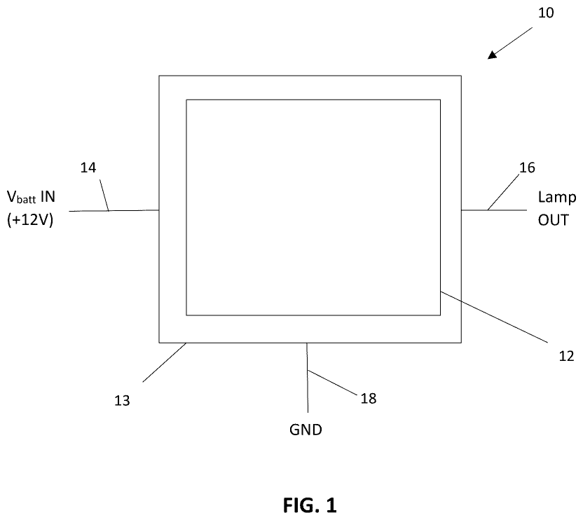

With reference to FIG. 1, a brake light modulation device 10 is shown. The device 10 is configured for installation in an existing brake line circuit of a vehicle and is designed to modify the behavior of the rear brake light in a vehicle (e.g., car, truck, etc.) in which it is installed. The device 10 may be particularly configured as an aftermarket component configured for installation in the brake light circuit of a vehicle.

The device 10 is generally provided in modular form with a printed circuit board 12 encased within a housing 13 (e.g., a plastic shell). Three terminals 14, 16, 18 extend from the circuit board and are available via the exterior of the housing (which terminals may also be referred to as “leads”). Two of the terminals 14, 16 are configured for connection to a severed brake light input line of a brake light circuit for the vehicle, one terminal 14 connected to the battery side of the circuit and one terminal 16 connected to the brake light side of the circuit. One of the terminals 18 is configured as a connection to ground within the brake light circuit. In particular, the V+ (+12V) 14 and Lamp (OUT) 16 terminals are configured for installation in a severed brake light supply line 112 (i.e., the line of the brake light circuit that receives a voltage/current upon application of the brakes by the driver of the vehicle; the brake light input line may also be referred to as a “brake light input line”). The GND terminal 18 is configured for connection to ground of the vehicle brake light circuit (which may also be referred to as a “return line”).

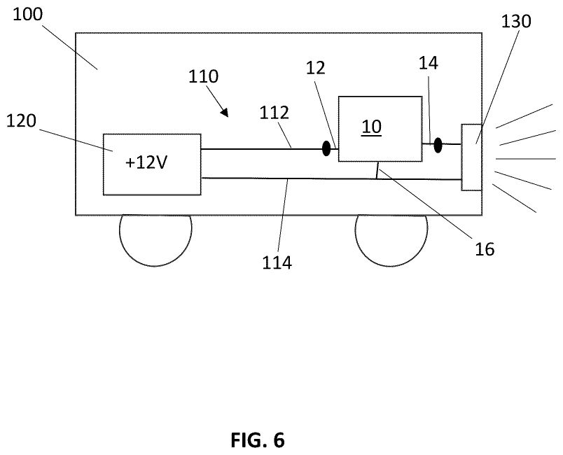

As shown in FIG. 6, the brake light modulation device 10 is installed in a brake line circuit 110 of a vehicle 100. The brake line circuit 110 is provided by brake light wiring including a supply line 112 and a return line 114 (i.e., ground line). The supply line 112 is severed and the device 10 is connected to the two severed ends of the severed supply line 112. The first terminal 14 is connected to the end of the supply line 112 that leads to the vehicle battery 120. The second terminal 16 is connected to the end of the supply line 112 that leads to the vehicle brake lights 130. The third terminal 18 is connected to the ground line 114. The brake lights 130 may be any type of brake lights used in automotive or other vehicles, including LEDs and incandescent lights. As explained in further detail below, the brake light modulation device is configured to modulate the power provided to the brake light, thus providing a flashing effect for the brake light. Advantageously, the brake light modulation device 10 is configured to measure the typical current delivered through the brake light circuit and maintain that current within the supply line 112 and the ground line 114 while still modulating the power provided to the brake light. Accordingly, the brake light modulation device 10 may be used in association with any number of different vehicles without tripping a brake light circuit warning/fault condition, including different vehicles with different operating voltages and expected currents through the brake light circuit.

### Operation of an Exemplary Brake Light Modulation Device

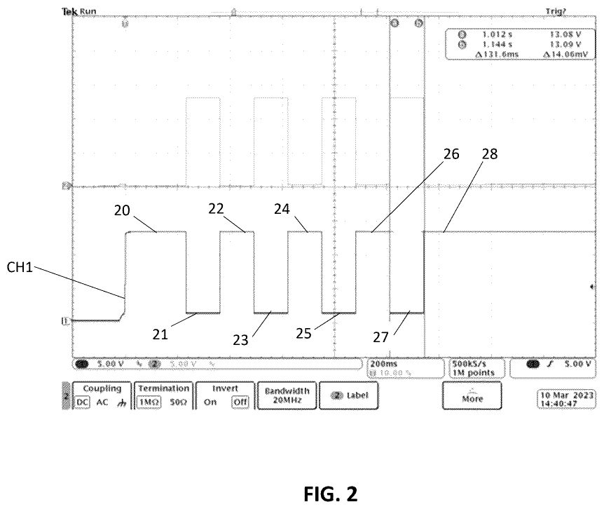

Operation of the brake light modulation device 10 is now shown with reference to the graph/oscilloscope reading of FIG. 2. The bottom trace (CH1) in FIG. 2 is the output voltage at the output terminal 16 of the brake light modulation device (i.e., Lamp OUT of FIG. 1). The upper trace (CH2) in FIG. 2 is an internal signal that is not discussed in detail herein.

When the driver of the vehicle presses on the brake pedal, voltage is applied by the car's electronics (e.g., the vehicle battery) to the V batt IN terminal 14 (which is usually in the 12-15V range for cars and trucks), and remains present while the brake pedal is depressed. At the same time, the output at the Lamp OUT terminal 16 turns on (i.e., goes high) for an initial period of about 230 ms (i.e., as noted by pulse 20 in FIG. 2), and is then turned “off” (i.e., stepped down to a low voltage for a short period of time of about 65 ms). The output voltage during this “off”/low voltage period is not zero, but is significantly less (e.g., 10 times less) than during the “on” period and is sufficiently close to zero such that the brake light is much dimmer than during the initial 230 ms on period. After this initial on-off flash, the output of the device 10 then modulates on and off three additional times with each on or off-interval spanning about 130 ms (see on pulses 22, 24 and 26 in FIG. 2 and the associated off periods 21, 23, 25, 27 in-between the on pulses, wherein such on pulses may also be referred to herein as “on-intervals” and such off periods may also be referred to herein as “off-intervals”). These on-off pulses 20-28 result in an apparent flashing of the vehicle brake light to the human eye during an initial flash period.

After the initial flash period, the output at the Lamp OUT terminal 16 goes steady high (i.e., as noted in FIG. 2 by period 28), and stays high until the driver releases the brake pedal. As noted previously herein, this flashing operation is more attention getting than the standard brake light operation, thus leading to fewer rear-end collisions in vehicles. The total time from the application of voltage at the V batt IN terminal 14 to a solid output at the Lamp OUT terminal 16 is about 1.14 seconds (i.e., 230 ms [initial on period]+7*130 ms [7 off-on periods following the initial on]=approx. 1.14 seconds total until steady on period 28).

In “stop-and-go” situations, with multiple braking intervals coming close together, the repeated flashing operation may become annoying for drivers behind the vehicle. To avoid this, a 5-second lockout mechanism may be employed in the brake light modulation device 10. The flashing is not engaged if a subsequent braking event occurs within some time period (e.g., 5 seconds) after previously releasing the brake.

It will be recognized that the brake light modulation device 10 disclosed herein may be configured with any number of different features. In at least one embodiment, the brake light modulation device is configured to provide the following advantageous features:
1. The ability to maintain a constant input current to the device 10 (i.e., no change in input current between on and off intervals); this feature is advantageous because certain vehicles monitor the brake light current and can signal a fault condition when the input current falls to zero during the off-intervals.
2. The use of pulse-width modulation (PWM) during the off-intervals to provide a reliable and controlled low-level off-interval activation of the brake light (e.g., in at least some embodiments, a duty cycle of less than 10% is implemented, and specifically a duty cycle of 5% at 102 Hz is implemented, or 5%+/−1%); this results in the brake light being 100% on during the “on” intervals and pulsed with a 5% duty cycle during the “off” intervals. The use of PWM accurately controls the off-interval brake light intensity irrespective of load current. PWM is capable of accomplishing this because the human eye effectively integrates the light pulses which are produced above the flicker/flash frequency.
3. The ability to manage instances wherein the battery voltage supplied to the input terminal (i.e., V_{batt} IN 14) is PWM modulated by the car's electronics. PWM modulation of the brake light voltage may be employed by the vehicle to fine tune the brake light's intensity via software, handle via software different intensity requirements that vary from country to country, or handle a range of brake light efficiencies from different suppliers.

### Exemplary Circuit for Brake Light Modulation Device

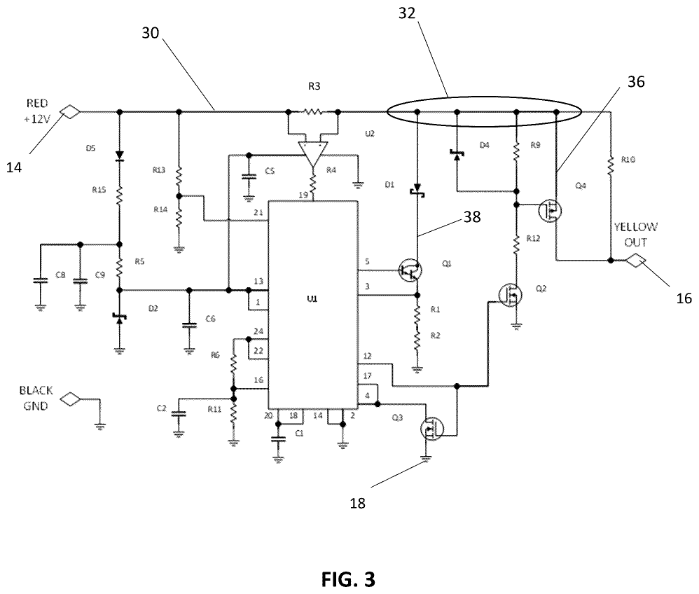

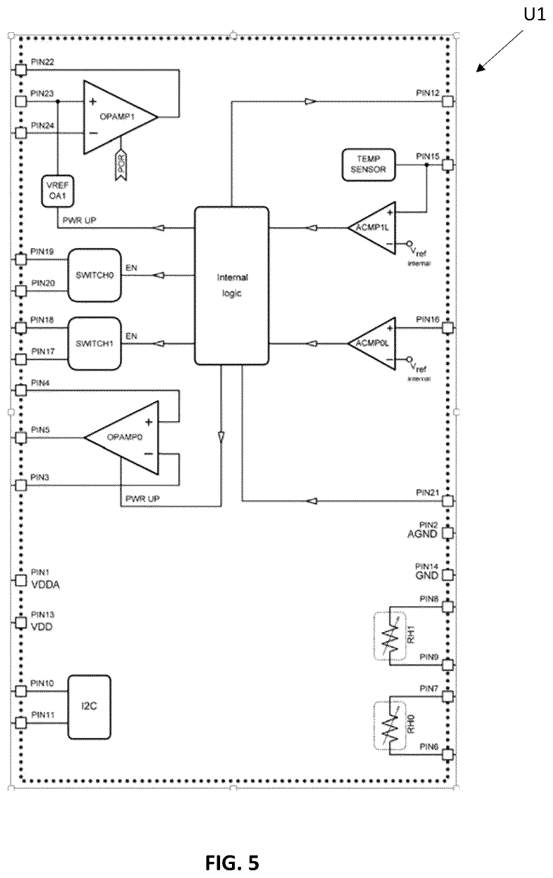

With reference now to FIG. 3, an exemplary circuit arrangement for a brake light modulation device 10 is shown with the above-referenced features. In order to keep the input current constant whenever the brake is applied, the disclosed embodiment implements the following scheme:
The on-interval input current is measured using an input current detector provided by a sense resistor (R3) and amplifier (U2). The magnitude of the measured input current is delivered to a controller (U1). The magnitude of the measured input current delivered to the controller is temporarily stored on as a representative voltage on capacitor (C1).
During the off-interval, an alternate load path is activated inside the device (i.e., via D1, Q1, R1 and R2). Using an op-amp, sense resistor, and a Darlington transistor (Q1), a constant current is sent through this alternate load path at the same value as during the on-interval.
The constant current through the alternate load path action involves the Darlington transistor absorbing and dissipating power. The dissipated power will be short lived (occurring only during the off-interval pulses), but can be significant, and will increase with brake light current. For example, with 13V and a 2.5 A current, the resulting power in the transistor will be 32.5 W.
During multiple braking intervals, heat may build up inside the transistor and in the device (which is small and sealed), so cooling of the devices is desired.
To avoid excess heat, a temperature sensor is used within the controller U1. An exemplary temperature sensor is shown in association with pin #15 of U1 in FIG. 5. If the internal printed circuit board (PCB) temperature of U1 exceeds a threshold, flashing operation is deactivated by U1 (i.e., modulation of the output current is suspended), thus causing the brake light to operate normally. Once the temperature drops below the activation threshold, normal flashing/modulation operation as described above is resumed.

Operation of the circuit of FIG. 3 is now described in further detail in association with the various circuit components. U1 is a Mixed Analog/Digital A SIC that has been configured to implement the features disclosed herein. U1 may also be referred to herein as a “controller” or “control circuit.”

The circuit of FIG. 3 includes three leads, including a first lead 14 configured for connection to the battery side of the brake detection line (identified in FIG. 3 at RED +12V terminal), a second lead 16 configured for connection to the brake light side of the brake detection line (identified in FIG. 3 as the YELLOW OUT terminal), and third lead 18 configured for connection to ground connection line (identified in FIG. 3 as the BLACK GND terminal). A main input path 30 to the circuit of FIG. 3 is through the first lead 14. This main input path 30 leads to a shunt node 32 where the input path splits into a main output path 36 and a shunt path 38. The output path 36 is connected to the second lead 16. The shunt path 38 leads to a ground connection at the third lead 18. The controller U2 controls operation of the current through the output path 36 and the shunt path 38 in order to modulate the light emitted from the brake light 130 while maintaining the current through the device 10 constant.

The input current along the main input path 30 of the device 10 is sensed through an input current detector provided by resistor R3 and amplifier U2, wherein U2 is a current sense amplifier with a gain of 20. For example, a 1A input current will result in 10 mV across R3, and 200 mV at the output of U2. This voltage represents the sensed input current and is stored on capacitor C1. In the embodiment of FIG. 3, resistor R3 is connecting across the inverting input and the non-inverting input of the amplifier U2.

The main output path 36 of the circuit of FIG. 3 includes an output transistor Q4 which is controlled by the controller U2. The controller U2 turns on the output transistor Q4 in order to supply voltage to the output terminal 16 (noted by “YELLOW OUT” in FIG. 3, also referred to as “Lamp OUT” herein), including during “on” intervals of modulation of the brake light. In the embodiment disclosed herein, the transistor Q4 is a P-Channel MOSFET. As described previously herein, the output terminal 16 is connected to the “+” lead of the vehicle brake light 130 when installed in a vehicle brake light circuit 110, and the “−” lead of the vehicle brake light is connected to ground 18 via the ground line 114. Q4 is activated whenever the N-Channel MOSFET Q2 is on, which is activated by a voltage on U1 pin #12.Specifically, a gate of Q4 is connected to a drain of Q2. Accordingly, the controller is configured to deliver a control signal to a gate of Q2 in order to activate Q2 and control current flowing through the output transistor Q4 in the output path. Zener D4 protects the gate of Q4 from damage due to voltage spikes.

The alternate “off” interval current path is provided through the shunt path 38 which extends between the shunt node 32 and the ground connection 18. In the embodiment disclosed herein, the shunt path 38 includes a Zener diode D1, a shunt transistor Q1, a first resister R1 and a second resister R2. In the embodiment disclosed herein, the shunt transistor Q1 is a Darlington transistor. During off-intervals of modulation of the brake light (i.e., when the brake light is dim), an op-amp inside U1 drives the base of Darlington transistor Q1 such that the voltage across R1 and R2 is equal to the stored voltage on C1. This causes the same current (or nearly the same current) to flow through Q1 during the off-interval of modulation as the current that flows through Q4 during the on-interval of modulation.

With continued reference to FIG. 3, it will be noted that a 5.1V power supply for U1 and U2 is derived from the +12V input by the network consisting of D5, R15, R5, C8, C9, D2, C5, and C6. This power circuit is configured to handle the input PWM voltage supplied by different cars. Resistor R13 and R14 provide an input voltage detector in the form of a voltage divider that allows U1 to instantaneously sense the presence of the input voltage. R10 is a large resistor that may be used in some embodiments to bypass the output MOSFET, allowing some small amount of current to be supplied to the brake light during the pulsed off-intervals.

R6, R11 and C2 provide a time constant for the lockout operation following modulation period (e.g., a 5-second lockout). For example, following an initial modulation of the brake lights some lockout period of time (e.g., 5 seconds) may be required before any subsequent modulation periods. This prevents the brake lights from repeatedly flashing when the driver of the vehicle repeatedly presses the brake pedal such as during times of start-and-stop traffic.

The PCB assembly that retains the circuit of FIG. 3 may be arranged as a relatively small component with electronics arranged on both sides of the PCB. In at least one embodiment, the PCB measures approximately 1.28″×0.43″, and the housing 13 that retains the PCB for the device 10 is only slightly larger.

Exemplary Embodiment with Further Modulation During Off-Intervals

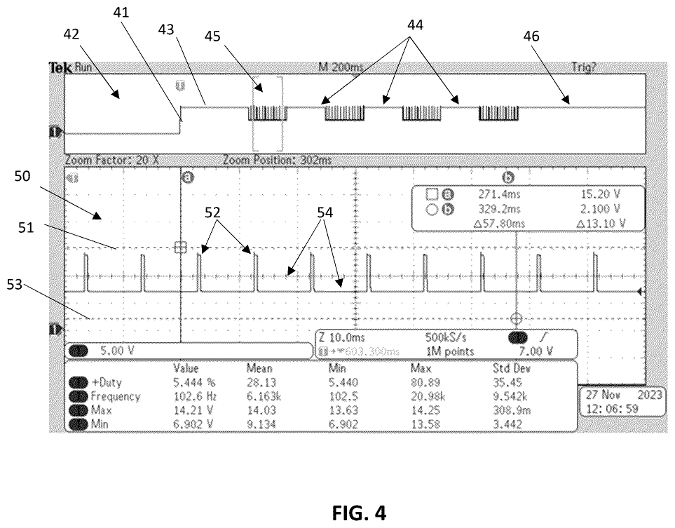

In the above described embodiments, output waveform of the brake light modulating device 10 includes on-intervals and off-intervals. However, in at least one embodiment, further modulation of the brake lights occurs within the off-intervals. With reference now to FIG. 4, a graph is shown of the output waveform for the brake light modulation device 10 (i.e., the output at Lamp OUT 16 of FIG. 1). The top pane 42 of FIG. 4 shows a zoomed-out view of the Lamp OUT voltage (i.e., the voltage at terminal 16) at 200 ms/division. The step at point 41 on the graph indicates a moment when a user of a vehicle presses on a brake pedal and voltage is detected on the brake line circuit 110. Following an initial time period 43 after depression of the brake pedal, the brake light modulation device 10 begins to modulate the Lamp OUT voltage 16. This modulation of the Lamp OUT voltage 16 includes a plurality of “on” intervals 44 with an “off” interval” 45 between each “on” interval. After initial modulation during the braking event, the Lamp OUT voltage is moved to “constant on” for a lockout period 46 wherein the Lamp OUT voltage remains high and does not return to modulation until after this lockout period 46. As will be recognized from the top pane 42, the Lamp OUT 16 voltage is held steady at a high state during the “on” intervals 44. In contrast, the Lamp OUT 16 voltage is modulated between step-up and step-down voltages during the “off” intervals. This modulation between step-up and step-down voltages during the “off” intervals may be referred to herein as “sub-modulation” (i.e., a “sub-modulated” voltage delivered during the off-intervals is a voltage that is not steady and is instead modulated during the off periods of a voltage signal that is already modulated between on-intervals and off-intervals).

The bottom pane 50 of FIG. 4 shows a close-up/zoomed-in view of an “off” interval of the brake light modulation device 10. As shown in the bottom pane 50 of FIG. 4, the Lamp OUT 16 voltage during each “off” interval 45 is defined by a plurality of “step-up” 52 intervals and a plurality of “step-down” intervals 54. It will be recognized that during the “step-up” intervals 52, the Lamp OUT voltage 16 is close to (or the same as) that during the “on” intervals (the voltage during the “on” intervals 44 is illustrated by a dotted line 51 in FIG. 4). During the “step-down” intervals 54 wherein the Lamp OUT voltage 16 is significantly less than during the “step-up” intervals 52 (e.g., the Lamp OUT voltage during “step down” interval 54 is ⅓, ½, ⅔, etc. the Lamp OUT voltage during interval “step up” interval 52). However, during the “step-down” intervals 54, the Lamp OUT voltage is still greater than zero (with zero illustrated by dotted line 53 in FIG. 4). In at least one embodiment, the “off” interval 45 is defined by 5% PWM at 102 Hz.

The above-described sub-modulation during the off-intervals may be advantageous for certain applications. For example, the sub-modulated off-intervals may result in an acceptable amount of light being emitted from the LED during the off-interval while still giving the appearance of an “off” or significantly dimmed LED state to the human eye.

### Further Detail of an Embodiment of the Controller

With reference now to FIG. 5, a block diagram showing an embodiment of a controller for the brake light modulation device is shown, and particularly an embodiment of ASIC U1 of FIG. 3. In FIG. 5, op-amp OPAM PO (pin #s 3, 4 and 5) together with external components Q1, R1 and R2, form the alternate constant-current shunt path discussed above in association with FIG. 3. OPAMP1 (pin #s 22, 23 and 24) buffers the 2.048V reference (which is used to ensure good accuracy of the 5-second lockout timing despite variations in input voltage). Comparator ACM POL is used for lockout timing. Comparator ACM PIL is activated by the internal temperature sensor. Analog switches SWITCH0 and SWITCH1 are used to switch the storage capacitor C1 and control the alternate current path. Various other circuit elements inside U1 (gates, counters, oscillators) are used to generate the timing and control logic needed for correct operation.

While an exemplary embodiment of the brake light modulation device 10 has been disclosed above, it will be recognized that other embodiments are possible. For example, in at least one embodiment the Darlington transistor Q1 may be replaced by an N-Channel MOSFET. Of course, numerous other substitute components and circuit arrangements are possible and contemplated herein.

The embodiment of the brake light modulation device disclosed herein is specifically designed to work with any number of different vehicles having different brake light currents. Other brake light modulation devices may be configured for operation only with a specific brake light current (e.g., 725 mA). In such designs, an alternate path circuit may be implemented that attempts to keep the input current constant. For example, in some designs a P-Channel MOSFET may be used that switches the input voltage into ground through two 36 ohm resistors in parallel, resulting in approximately 725 mA. However, this scheme may only work if the brake light current is close to 725 mA. If the brake light current of a vehicle is significantly higher or lower than this, it is possible that this vehicle might throw a fault. Accordingly, the brake light modulation device disclosed herein has significant advantages over other brake light modulation devices, as the brake light modulation device disclosed herein is configured for use with many different vehicles and does not result in a fault condition.

### Method of Modulating a Vehicle Brake Light

In view of the foregoing, it will be appreciated that a method of modulating a vehicle brake light is disclosed herein. The method includes installing the brake light modulation device 10 as an aftermarket part in a vehicle. The method begins by first cutting a brake light supply line of the vehicle in order to provide a severed brake line, and connecting the brake light modulation device to the brake light circuit. In order to do this, the V+ terminal 14 of the brake light modulation device 10 is connected to the side of the severed brake light supply line that leads to the battery, and the Lamp (OUT) 16 terminal is connected to the side of the severed brake light supply line that leads to the brake lights. The GND terminal 18 is connected to the ground line brake light circuit. Once installed, the brake lights of the vehicle may be modulated with the device detection of any fault condition by the vehicle. Specifically, when a user presses the brake pedal and applies the vehicle brakes, this results in a voltage being present on the brake detection line. This results in the standard current flowing through the brake light circuit. The standard current is detected by the brake light modulation device 10 during an initial braking period and stored by the device. Thereafter, the brake light modulation device controls the current flow through the output transistor Q4 and the shunt transistor Q1 in order to modulate the brake lights as described above during a modulation period. During this modulation period, the device 10 also maintains a constant current (i.e., the standard current) through the brake light by controlling the transistors Q1 and A4 such that the input current to the device 10 does not fluctuate in a manner that results in a fault condition in the vehicle. Following an initial modulation period, the device 10 ceases modulation for a lockout period. Thereafter, modulation begins again if the user again applies the vehicle brakes.

The foregoing detailed description of one or more embodiments of the brake light modulation device has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by any appended claims. Therefore, the spirit and scope of any eventually appended claims should not be limited to the description of the embodiments contained herein.

What is claimed is:

1. A brake light modulation device configured for installation in a brake line circuit of a vehicle, the brake line circuit including a supply line and a return line, the brake light modulation device comprising:
a first lead, a second lead and a third lead, wherein an input path is connected to the first lead, an output path is connected to the second lead, and a ground connection is provided at the third lead;
an input current detector connected to the input path, the input current detector configured to detect a magnitude of a current applied to the input line;
an output transistor arranged in the output path;
a shunt transistor arranged in a shunt path extending between a shunt node and the third lead, the shunt node connecting the input path to the output path; and
a controller configured to:
receive a current signal from the input current detector, the current signal indicative of the magnitude of the current applied to the input line during a vehicle braking event including during an initial time period of the vehicle braking event, and
provide control signals to the output transistor and the shunt transistor, the control signals configured to (i) modulate an output current delivered through to the output path at the second lead after the initial time period during the vehicle braking event and (ii) maintain the magnitude of the current applied to the input line after the initial time period such that the magnitude of the current applied to the input line remains constant during the vehicle braking event.

2. The brake light modulation device of claim 1 further comprising an input voltage detector connected between the first lead and the third lead, the input voltage detector configured to detect a voltage applied between the first lead and the third lead, the controller further configured to receive a voltage signal from the input voltage detector, the voltage signal indicative of an input voltage detected between the input path and the ground connection.

3. The brake light modulation device of claim 1 wherein the input current detector is provided by a sense resistor and a current sense amplifier.

4. The brake light modulation device of claim 3 wherein the sense resistor is connected across an inverting input and non-inverting input of the current sense amplifier, and wherein an output of the current sense amplifier is connected to the controller.

5. The brake light modulation device of claim 1 further comprising a capacitor connected to the controller and configured to store a voltage representative of the magnitude of the current applied to the brake line circuit of the vehicle.

6. The brake light modulation device of claim 1 wherein the shunt transistor is a Darlington transistor and the controller is configured to deliver a control signal to a base of the Darlington transistor to control current flowing through the shunt path.

7. The brake light modulation device of claim 1 wherein the output transistor is a first MOSFET, wherein a gate of the first MOSFET is connected to a drain of a second MOSFET, wherein the controller is configured to deliver the control signal to a gate of the second MOSFET in order to activate the second MOSFET and control current flowing through the first MOSFET.

8. The brake light modulation device of claim 1 wherein the controller is an application specific integrated circuit (A SIC) device.

9. The brake light modulation device of claim 1 wherein the shunt path includes the shunt transistor, a diode and at least one transistor.

10. The brake light modulation device of claim 1 wherein the brake light modulation device is retained within a housing with the first lead, second lead and third lead extending out of the housing.

11. The brake light modulation device of claim 1 further comprising a temperature sensor, wherein the controller is configured to suspend modulation of the output current when a temperature signal from the temperature sensor exceeds a threshold.

12. The brake light modulation device of claim 11 wherein the controller and temperature sensor are provided on a printed circuit board.

13. The brake light modulation device of claim 1 wherein the control signals configured to modulate the output current include control signals for a plurality of on-intervals and a plurality of off-intervals, wherein each off-interval is further defined by sub-modulation during said off-interval.

14. A brake light modulation device configured for installation in a brake line circuit of a vehicle, the brake line circuit including a supply line and a return line, the brake light modulation device comprising:
a first lead, a second lead and a third lead, wherein an input path is connected to the first lead, an output path is connected to the second lead, and a ground connection is provided at the third lead;
a first transistor connected between the first lead and the second lead;
a second transistor connected between the first lead and the third lead; and
a controller configured to provide control signals to a first transistor and the second transistor, the control signals configured to modulate an output voltage at the second lead between a plurality of on-intervals and a plurality of off-intervals, wherein a steady output voltage is provided during the on-intervals, and wherein a sub-modulated output voltage is provided during the off-intervals.

15. The brake light modulation device of claim 14 wherein the first transistor is an output transistor arranged in the output path and the second transistor is a shunt transistor arranged in a shunt path extending between a shunt node and the third lead, the shunt node connecting the input path to the output path.

16. The brake light modulation device of claim 15 further comprising an input current detector connected to the input path, the input current detector configured to detect a magnitude of a current applied to the input line, wherein the controller is further configured to receive a current signal from the input current detector, the current signal indicative of the magnitude of the current applied to the input line during a vehicle braking event including during an initial time period of the vehicle braking event.

17. The brake light modulation device of claim 16 wherein the control signals from the controller are further configured to (i) modulate an output current delivered through to the output path at the second lead after the initial time period during the vehicle braking event and (ii) maintain the magnitude of the current applied to the input line after the initial time period such that the magnitude of the current applied to the input line remains constant during the vehicle braking event.

18. The brake light modulation device of claim 14 wherein the output voltage is pulse-width-modulated (PWM) with a duty cycle of less than 10%.

19. The brake light modulation device of claim 18 wherein the output voltage is modulated with a duty cycle of 5% at 102 Hz.

20. A method controlling illumination of a brake light in a brake light circuit of a vehicle, the brake light circuit including the brake light and brake light wiring, the brake light wiring including a brake light supply line and a return line, the method comprising:
cutting the brake light wiring such that at least one line of the brake light wiring is a severed line, the severed line including a first severed end and a second severed end;
connecting a first terminal of a brake light modulation device to the first severed end;
connecting a second terminal of the brake light modulation device to the second severed end;
connecting a third terminal of the brake light modulation device to the brake light wiring;
applying a vehicle brake; and
controlling current flow through an output transistor and a shunt transistor in order to modulate illumination of the brake light, wherein said modulation includes on-intervals and off-intervals, wherein controlling current flow through the output transistor and the shunt transistor during the off-intervals includes sub-modulating illumination of the brake light during the off-intervals.
